(19) United States
(12) Patent Application Publication
(10) Pub. No.: US 2007/0131713 A1
(43) Pub. Date: Jun. 14, 2007

(54) Disposable Dispensing Container

(76) Inventor: Michael John Hill, Cedar Falls, IA (US)

Correspondence Address: PATWRITE LLC, 408 W. MAIN ST., MARSHALLTOWN, IA, 50158-5759, US

(21) Appl. No.: 11/610,492

(22) Filed: Dec. 13, 2006

Related U.S. Application Data
(60) Provisional application No. 60/749,563, filed on Dec. 13, 2005.

(51) Int. Cl. B67D 1/16

(52) U.S. Cl. 222/108; 222/107; 222/494

(57) ABSTRACT

A disposable dispensing container comprises a body with a fillable cavity that is sealed at one end after filling with selected contents. The contents are contained with a frangible seal that is broken by the user to access the contents. A spill collar protects the contents from dripping out after rupturing the frangible seal and is contiguous with the frangible seal and may be shaped to provide further dispensing control of contents. A sanitary seal may cover the open end of the spill collar to keep any contaminants away from the interior prior to use. The cavity may be lined with a sterile layer to protect the contents. Contents may be powders or liquids and may include things like ketchup, mayonnaise, sugar or lubricating oil.

### RELATED APPLICATIONS

This application claims priority and herein incorporates by reference U.S. provisional patent application 60/749,563, filed Dec. 13, 2005.

### BACKGROUND OF THE INVENTION

Anyone who has ever eaten at a fast food restaurant knows the frustration of trying to open a ketchup package only to have it tear all the way down the side and make a mess. Additionally, it requires two hands to open the package and if the user's hands are greasy, it becomes an impossible task.

Often, travel shampoo and other personal care products are packaged in small bottles or packets that are difficult to use and control the amount of product dispensed, especially when the user's hands are wet.

Another challenge is presented when trying to add motor oil to an engine from oil containers without spilling some product on the engine. The introduction of plastic spout containers helped, but you still have to turn an open container upside down and quickly target the opening. The result is often spilled oil on the engine.

There is a need for a disposable dispensing container that overcomes the limitations of the existing art.

### SUMMARY OF THE INVENTION

A disposable dispensing container comprises a body with a fillable cavity that is sealed at one end after filling with selected contents. The contents are contained with a frangible seal that is broken by the user to access the contents. A spill collar protects the contents from dripping out after rupturing the frangible seal and is contiguous with the frangible seal and may be shaped to provide further dispensing control of contents. A sanitary seal may cover the open end of the spill collar to keep any contaminants away from the interior prior to use. The cavity may be lined with a sterile layer to protect the contents. Contents may be powders or liquids and may include things like ketchup, mayonnaise, sugar or lubricating oil.

Other features and advantages of the instant invention will become apparent from the following description of the invention which refers to the accompanying drawings.

### BRIEF DESCRIPTION OF THE DRAWINGS

FIG. 1 is a top view of a disposable dispensing container according to an embodiment of the present invention.

FIG. 2 is a side view of the disposable dispensing container shown in FIG. 1.

FIG. 3 is a cutaway view of the disposable dispensing container shown in FIGS. 1 and 2.

FIG. 4 is a top view of a disposable dispensing container according to an embodiment of the present invention.

FIG. 5 is a side view of the disposable dispensing container shown in FIG. 4.

FIG. 6 is a cutaway view of the disposable dispensing container shown in FIGS. 4 and 5.

FIG. 7 is a perspective view of the disposable dispensing container shown in FIGS. 1, 2 and 3.

FIG. 8 is a perspective view of the disposable dispensing container shown in FIGS. 4, 5 and 6.

FIG. 9 is a transparent perspective view of a disposable dispensing container according to an embodiment of the present invention.

### DETAILED DESCRIPTION OF THE INVENTION

Reference is now made to the drawings in which reference numerals refer to like elements.

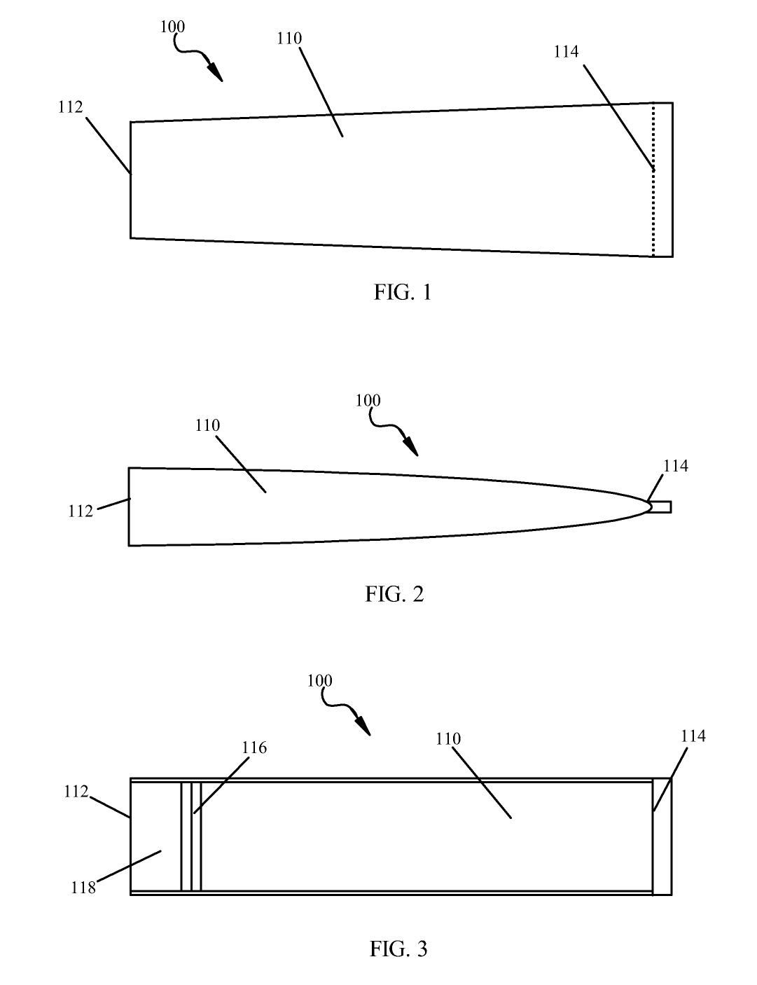

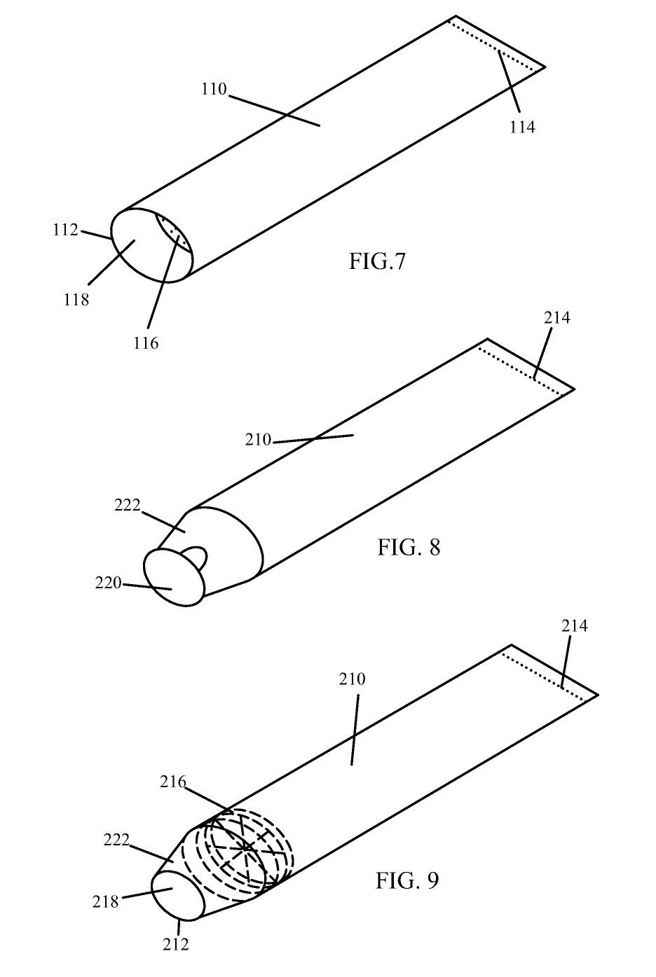

Referring to FIGS. 1, 2, 3, 7 and 1 2, a disposable dispensing container 100 is shown having a body 110 with dispensing end 112 and a sealed end 114. A frangible seal is disposed proximal to dispensing end 112 and protects the contents of container 100. A spill collar 118 is provided to control the contents after frangible seal 216 is ruptured. Frangible seal 216 may have pre-stressed failure panels 228 which are designed to break when a given pressure is applied. Other frangible valves may be used as long as the contents remain contained until use as is known in the art.

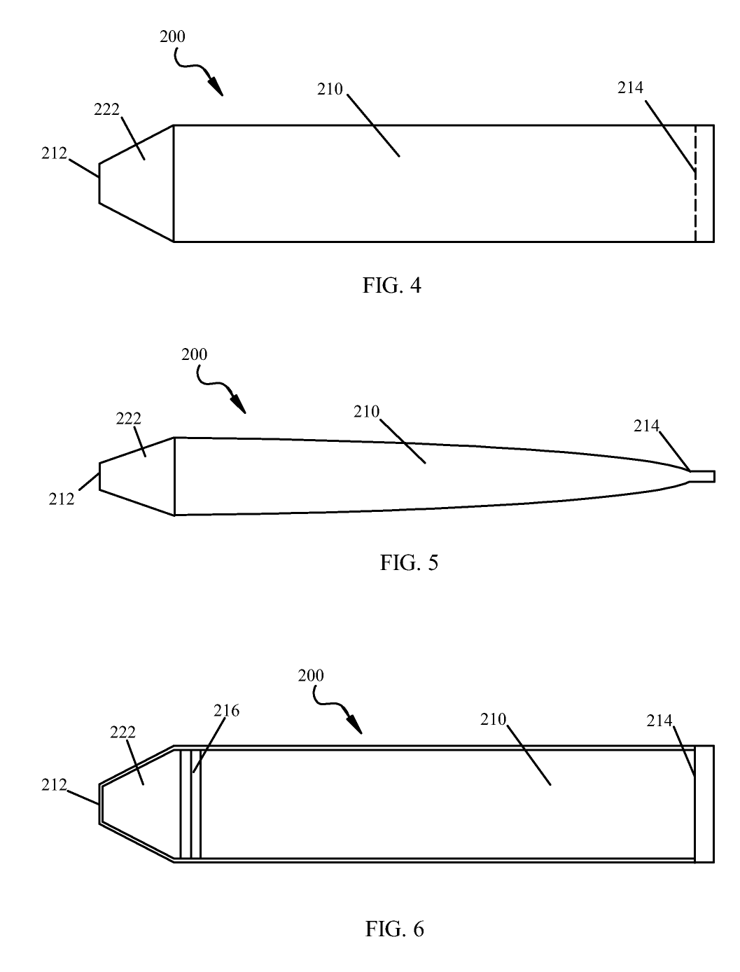

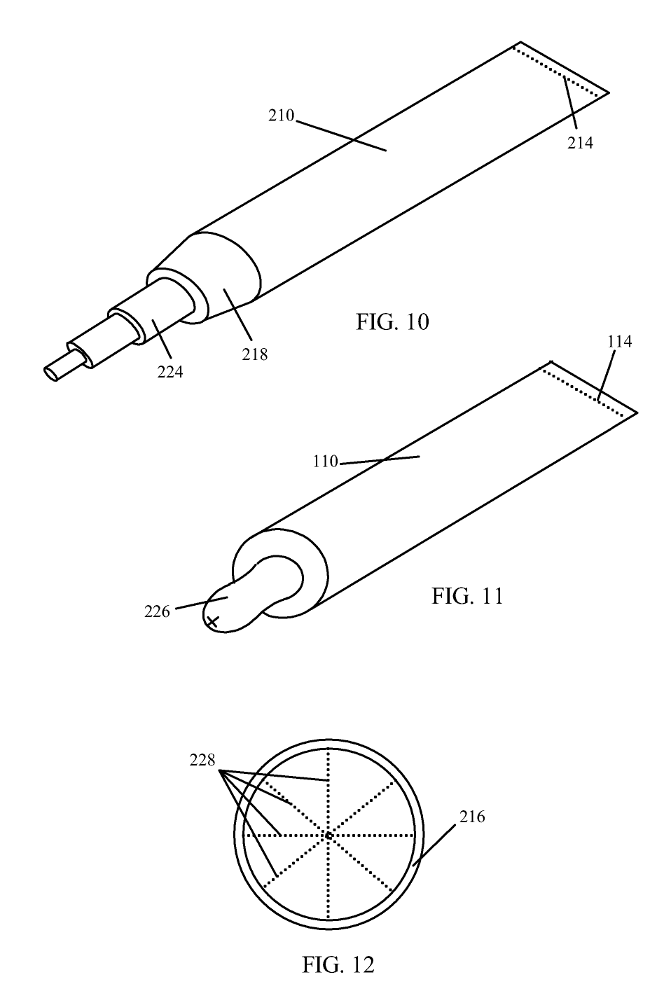

Referring now to FIGS. 4, 5, 6, 8, 9 and 12 another embodiment of a disposable dispensing container 200 is shown having a body 210, a sealed end 214, a frangible seal 216 and a dispensing end 212. A shaped spill collar 222 is adjacent to frangible seal 216 and acts as a product guide to control and dispense the product. The opening in shaped spill collar 222 may be shaped as well such as a thin slit, round or oval opening or other shape depending on the intended application. A sanitary seal 220 may be placed over shaped spill collar 222 to keep contaminants out of dispensing end 212.

FIG. 10 shows a disposable dispensing container having a shaped spill collar 224 that is designed to meet particular applications such as dispensing oil or glue. FIG. 11 illustrates an embodiment with a feeding nipple 226 attached. Other attachments could be used depending on the application.

Disposable dispensing container 210 may be made of plastic, paper, vinyl aluminum, rubber and synthetic rubber like compounds such a silicone. In some applications, it may be advantageous to make the body in layers with an outer protective layer covering a sterile plastic interior layer. This embodiment is especially useful when containing food products such as condiments like ketchup, mayonnaise or mustard. In use, the product may be added through the seal end before the end is sealed and then to applying a heat crimp as is known in the art. In this way, the food is kept fresh until use. Of course other filling methods are acceptable including sealing the end first and then adding product before attaching the frangible valve or injecting the product through an injection port (not shown) which is then sealed as is known in the art.

Other items may be contained and dispensed using the present invention including but not limited to dispensing lubricating oil, shampoo, conditioners, water, soaps, glues, mouthwashes, shaving cream, prescriptions or over-the-counter medicines, creams, lotions, sugar and candy products.

Since it is difficult to dispense motor oil without spilling, the present invention is easily used by positioning dispensing end 222 over the motor fill tube (not shown) and then squeezing to rupture frangible seal 216 allowing the oil to fill without spilling.

Because the pressure needed to rupture frangible seal 216 is controllable, only a small force is required to use the present invention and; therefore, only one hand is required to open and dispense the product.

Although the instant invention has been described in relation to particular embodiments thereof, many other variations and modifications and other uses will become apparent to those skilled in the art.

What is claimed is:

1. A disposable dispensing container for holding and dispensing a selected content comprising:
a body defining an interior cavity having an open end and an opposing end capable of being sealed;
a frangible seal fixedly disposed within and bounded by said interior cavity at a region proximate said open end; and
a spill collar having an attachment end contiguous with said open end.

2. A disposable dispensing container for holding and dispensing a selected content according to claim 1 further comprising a sanitary seal removeably disposed over a distal end of said spill collar wherein an interior of said spill collar is protected until said sanitary seal is removed.

3. A disposable dispensing container for holding and dispensing a selected content according to claim 2 wherein said distal end of said spill collar has a smaller opening than said attachment end.

4. A disposable dispensing container for holding and dispensing a selected content according to claim 1 wherein said spill collar has a shape selected to match an application.

5. A disposable dispensing container for holding and dispensing a selected content according to claim 4 wherein said spill collar is made of a flexible material.

6. A disposable dispensing container for holding and dispensing a selected content according to claim 5 wherein said shape is a nipple.

7. A disposable dispensing container for holding and dispensing a selected content according to claim 4 wherein said shape is an elongated cone.

8. A disposable dispensing container for holding and dispensing a selected content according to claim 1 wherein said end capable of being sealed is sealed after filling said cavity with a selected content.

9. A disposable dispensing container for holding and dispensing a selected content according to claim 8 wherein said end capable of being sealed is sealed using heat welding.

10. A disposable dispensing container for holding and dispensing a selected content according to claim 1 wherein said body is made of plastic.

11. A disposable dispensing container for holding and dispensing a selected content comprising:
a body defining a cavity for holding said selected content;
said body having a dispensing end;
a frangible seal fixedly disposed to said body proximal to said dispensing end wherein said selected content is prevented from leaking out until said frangible seal is broken; and
a spill collar contiguous with said dispensing end.

12. A disposable dispensing container for holding and dispensing a selected content according to claim 11 further comprising a sanitary seal removeably disposed over a distal end of said spill collar for keeping an interior portion of said spill collar free from contaminants until said sanitary seal is removed.

13. A disposable dispensing container for holding and dispensing a selected content according to claim 11 further comprising a product dispensing attachment contiguous with a distal end of said spill collar for selectively dispensing said content in a controlled fashion.

14. A disposable dispensing container for holding and dispensing a selected content according to claim 11 wherein said content is a food product.

15. A disposable dispensing container for holding and dispensing a selected content according to claim 11 wherein said content is a powder.

16. A disposable dispensing container for holding and dispensing a selected content according to claim 11 wherein said content is a lubricant.

17. A disposable dispensing container for holding and dispensing a selected content according to claim 11 wherein said body is made of at least two layers.

18. A disposable dispensing container for holding and dispensing a selected content according to claim 17 wherein said at least two layers includes a sterile interior layer.

19. A disposable dispensing container for holding and dispensing a selected content according to claim 18 wherein said at least two layers includes an exterior metalized layer.

20. A disposable dispensing container for holding and dispensing a selected content according to claim 13 wherein said product dispensing attachment end is protected with a removable sanitary cover.
